(19) United States
(12) Patent Application Publication
(10) Pub. No.: US 2008/0114620 A1
(43) Pub. Date: May 15, 2008

(54) Software, system and method for computer based assessing of health insurance risk profiles for a group seeking health insurance and providing a composite insurance policy

(76) Inventor: Robert M. Donnelli, Scottsdale, AZ (US)

Correspondence Address: John J G Mullins, 1618 East Gate Way #304, Pleasanton, CA, 94566, US

(21) Appl. No.: 11/703,551

(22) Filed: Feb. 6, 2007

Related U.S. Application Data
(60) Provisional application No. 60/771,102, filed on Feb. 6, 2006.

(51) Int. Cl. G06Q 40/00

(52) U.S. Cl. 705/4

(57) ABSTRACT

The present invention provides a computer system including software with computer implemented methods for assessing health insurance risk profiles for a company group and for its individual employees, which system provides methods for assigning the appropriate health insurance costs and/or rates for the company group. In a preferred aspect, the software and methods provide an improved way to manage and control medical costs through lower administration and sales costs. The present invention further relates to electronic commerce in general, and, more particularly, to a computer implemented data processing system that provides an efficient market for the provision of insurance directly to those seeking insurance by an online computer insurance brokerage, rating and underwriting service that is combined with carrier and/or third party provider services and which may optionally avoid the need for those seeking such insurance to utilize a broker/agent/consultant.

### FIELD OF THE INVENTION

The present invention relates generally to a computer system including software with computer implemented methods for assessing health insurance risk profiles for a company group and for its individual employees, which system provides methods for assigning the appropriate health insurance costs and/or rates for the company group. In a preferred aspect, the software and methods provide an improved way to manage and control medical costs through lower administration and sales costs. The present invention further relates to electronic commerce in general, and, more particularly, to a computer implemented data processing system that provides an efficient market for the provision of insurance directly to those seeking insurance by an online computer insurance brokerage, rating and underwriting service that is combined with carrier and/or third party provider services and which may optionally avoid the need for those seeking such insurance to utilize a broker/agent/consultant.

### BACKGROUND OF THE INVENTION

Traditional company based employee health insurance programs are provided through a distribution system involving intermediaries in the form of brokers, agents, or consultants, who provide expertise in the gathering of data, formulating the data according to standards required by insurance carriers, interfacing with the carrier market regarding benefit plan options, and communicating back to the employer sponsor of the plan.

Over the years, this process has become institutionalized into a sort of mysterious “black box” with a proverbial veil drawn across the front to limit the view that is even give to a chosen few. Only special individuals in the insurance business (intermediaries to insurance providers) are allowed to “look inside” because it is too communicated to the common person as being complicated or scary or obtuse for them to grasp. Even this special group of intermediaries to insurance providers are not permitted to view the details behind the view that the see in the black box to either see how the view is constructed or to see how the view is presented. This has allowed insurance purchasing, especially for health plan benefit insurance, to become the single largest area of corporate procurement that has been left outside of any real or substantive control of the employer purchaser, unless they are self insured. Even self insured employers are often given a black box view of a program that is frequently constructed or administered by a third party (someone outside the employer's company).

As a result, companies typically use such an intermediary to intercede for them with the insurance industry, and that intermediary receives compensation from insurance carriers when business is placed with them as well as compensation, directly or indirectly, from the company client. Even when the intermediary role is played by a consultant who is directly paid a fee by the employer for “independent” advice, it is often the case that there are hidden, behind the scene commissions or bonuses that are ultimately paid to the consultant by the winning carrier. Not surprisingly, court cases have sprung up throughout the country (e.g., Texas, Ohio, and New York) involving situations where intermediaries are being brought to task for non-disclosure of conflicts of interest or side dealings, with hidden compensation and other activities that occur at the expense of the employer client. As a result of such conflicts of interests and side dealings, the employees of that employer and their dependents are the end users who end up paying more in direct payroll contributions that they need make to the cost of the employer health plan, or to the cost-sharing within the benefit plan itself (higher deductibles and coinsurance) as a result of such side dealings and extraneous direct or indirect compensations to intermediaries.

Many insurance entities tend to pay large amounts (as much as 15% of premiums on certain small employer market products) in sales commissions, not to mention internal marketing costs, renewal bonuses, production quota bonuses, special award and contest compensation, and the administration structure to manage the sales process. Many employers never even know whether they were presented with viable options or not when they rely strictly on intermediaries for input to their benefit design and cost research. However, companies are often “stuck” with such intermediaries since group and individual risk liability factors are frequently very complex to determine when trying to set up a new policy group. Often new companies calculated such liability factors based on a group claims history and/or manual factors, and this may include a corridor figure of typically 125% of the prior year insurance use rate for the primary major medical liability policy. Such increase can it difficult for the company to locate a new major medical insurer independently of an intermediary.

Companies can find it a challenge to even find an insurer who is willing to offer insurance at a reasonable premium, or to determine if the best value is the insurance offered Few insurers seem to provide most companies with more than a small subset of all of the types of insurance that an employer may need for their group policy. One insurer may offer only major medical and the other catastrophic coverage, where the risk assessments and premiums may be different. Therefore, an insurance seeking company may waste a lot of time filling out many complex forms for many different insurance companies in order to develop a full set of policies that cover the risks needed to be covered, and this may require payment of separate bills to different carriers.

While some federal centrally managed insurance programs only have a combined administrative and other overhead cost of about 5 to 10% of the total premium, copay and deductibles, and the majority of money going for actual medical expenses, overhead costs can be as high as 30% to 40% for many major medical insurance companies. Some of this increased cost may be due to intermediaries and the “black box” problems, where so much of premium rates for insurance polices may be “float” that goes to commissioned sales people and TPAs instead of paying for medical costs for the insured end users.

Accordingly, there is a need for insurance solutions and computer implemented methods that replace the above often overly expensive aspects of the health insurance coverage process, and to assist in the de-mystification of the black-box that purchasing insurance has become for so many employers and other purchasers of group health benefits for employees and their dependents. In particularly, there is a need for insurance solutions and computer implemented methods that give real cost value comparisons for particular insurance programs and help to replace the above expensive aspects and procedures with a composite insurance solution of high value for companies seeking group major medical insurance coverage in a cost effective manner that can optionally provide an acceptably lower cost burden for end users.

### DEFINITIONS

The following non-exhaustive list of definitions is used herein to define terms that may otherwise be confusing or can sometimes have multiple meanings. Each occurrence of a defined term in the above text, in the text that follows, or in the claims of this document, is to be given the meaning ascribed to it in the list of definitions below.

“Employer” as referred to in this document in the context of health or other insurance policies or premiums refers to the entity that is providing or wishes to provide a group health insurance program to its employees, an that wishes to obtain a quotation for consideration of purchase of a policy. Typically a group includes 25 employees or more.

“TPA” or “third party administrator” as referred to in this document in the context of health or other insurance policies or premiums is an entity serving in an administrative, clerical and booking keeping capacity, who among other functions may keep financial records of insurance use, insurance claims, claim payments or statistics of insurance use for an insurance provider and may act as a liaison between one or more pairs of parties selected from an insurance client (employer), a medical or dental care provider, an employee who uses insurance, and a financing vehicle/underwriting entity or a self-insured employer department responsible for financing insurance payments.

“Intermediary” as referred to in this document in the context of health or other insurance policies or premiums refers to the entity that is serving as the liaison between the insurance client prospect employer and the financing vehicle/underwriting entity. The intermediary may be an agent, a broker, a consultant, or a marketing representative of a third party provider (TPA) or insurance entity.

“Financing Vehicle/Underwriting Entity” (usually an insurance provider entity) as referred to in this document in the context of health or other insurance policies or premiums may be an insurance company, PPO, HMO, health plan, or an authorized representative of such entities, such as a Managing General Underwriter, or even simply a TPA in the case of a fully self-insured employer (meaning, there is NO stop-loss insurance) who assesses financial risk and assigns premium costs for an insurance policy group, or its members. If the “risk” represented by the health insurance program is held entirely and solely by the employer, then there is no transfer of risk to an insuring entity of any kind. An insurance company may offer administrative services only without any insurance element, in which case they serve in the identical capacity of a TPA. A TPA may be both the servicing agent for the administrative services required for an insurance program and the intermediary between the client and an insuring entity for any transfer of risk (insurance element). By way of non-limiting example, in some embodiments of the invention, a financing vehicle can be a self-funded health plan WITH the presence of stop-loss insurance. A TPA may only be involved in the capacity of administrative services for a case that has reached the “sold case” status point, and may not provide an intermediary role, at least not for the initial contact and placement in some embodiments of the invention. An insurance company may be involved as the issuer of the stop-loss policy as part of an insurance package. They may be present in flow chart embodiments of the invention process as the MGU with regard to the rating, underwriting, policy issue, and policy and claims administration of the stop-loss insurance coverage.

“Carrier/Entity” (an entity who is underwriting the risk of insuring the health benefit plan and providing the particular financing vehicle/contract type utilized by the employer) as referred to in this document in the context of health or other insurance policies or premiums may be an insurance company, HMO, health plan, or an authorized representative of such entities, such as a Managing General Underwriter, or even simply a TPA in the case of a fully self-insured employer (meaning, there is NO stop-loss insurance) who assesses financial risk and assigns premium costs for an insurance policy group, or its members. If the “risk” represented by the health insurance program is held entirely and solely by the employer, then there is no transfer of risk to an insuring entity of any kind. An insurance company may offer administrative services only without any insurance element, in which case they serve in the identical capacity of a TPA. A TPA may be both the servicing agent for the administrative services required for an insurance program and the intermediary between the client and an insuring entity for any transfer of risk (insurance element). By way of non-limiting example, in some embodiments of the invention, a financing vehicle can be a self-funded health plan WITH the presence of stop-loss insurance. A TPA may only be involved in the capacity of administrative services for a case that has reached the “sold case” status point, and may not provide an intermediary role, at least not for the initial contact and placement in some embodiments of the invention. An insurance company may be involved as the issuer of the stop-loss policy as part of an insurance package for a self-funded employer. They may be present directly in flow chart embodiments of the invention process, or represented by an MGU with regard to the rating, underwriting, policy issue, and policy and claims administration of the stop-loss insurance coverage.

“NCC” or “Novo Client Case” as referred to in this document in the context of health or other insurance policies or premiums refers to a employer entity who is a prospective entity seeking group insurance and who has had no prior insurance or can provide no statistics with respect to current prior costs or use of insurance by employees within the prospective group.

“PQ” or “preliminary quote” as referred to in this document in the context of health or other insurance policies or premiums refers to a non-binding quote which is a preliminary estimate of premium and other costs to a prospective employer client entity who is seeking group insurance. The PQ is determined by an actuarial manual rating process based on preliminary basic input information provided by the prospect employer.

“MRE” or “manual rate engine” as referred to in this document in the context of health or other insurance policies or premiums refers to a computer process having software implemented methods to provide estimates of premium and/or other costs to a prospective employer client entity who is seeking group insurance. It may be used to generate either a preliminary cost estimate or PQ, or used in the process of blended experience rating that develops a bindable quote, or both.

“EOI” or “evidence of insurability” as referred to in this document in the context of health or other insurance policies or premiums refers to part of a hard copy or part of an electronic form for enrollment of an employee in a group insurance plan that helps to determine risk for that particular employee.

“MGU” or “managing general underwriter” as referred to in this document in the context of health or other insurance policies or premiums refers to one example of an entity contracted to perform certain functions of an insurance/entity, wherein the MGU is not the actual risk-taking entity.

“BCI” or “benefits cost index” as referred to in this document in the context of health or other insurance policies or premiums refers to computer implemented methods with computer implemented actuarial analysis methods that are conducted for the evaluation of a health benefits value factoring as a method to determine the true financial impact of health plan costs and benefits. Generally, such computer implemented methods analyze the benefit, burden or both the benefit and burden of an insurance policy for an individual or group of individuals based upon values that may be calculated or input with respect to the average cost of insurance coverage divided by the projected cost of end user coverage use. The result is the Benefits Cost Index (BCI), which is essentially the portion of total costs that are covered for a particular premium costs without any out of pocket. Logically, the lowest total annual premium costs with the highest BCI (lowest out of pocket percentage with respect to the coverage) might be regarded as representing the best value for end users. A consumer choice might be to seek the lowest annual premium costs having an acceptable BCI with regard to out of pocket expenditures. An employer might have an interest that seeks to lower the premium costs, while an end user might have an interest that seeks to lower out of pocket expenditures beyond the premium, and computer implemented methods that determine a BCI for a particular premium cost can be utilized as a factor to strike a balance between the two interests.

The “BBCI” or “Boloto Benefits Cost Index” as referred to in this document in the context of health or other insurance policies or premiums refers to computer implemented methods that utilize a BCI as defined above which calculates multiple factors including project end user use, deductibles, co-insurance, co-pays, etc. and delivers a benefit number. For example, the number is a percentage from 0 (all burden) to 100 (no out-of-pocket) for each dollar of utilization. Alternatively, the benefit number may be subtracted from 100% to provide the percent burden of a particular policy as a percentage of the premium. The BBCI can be utilized in an analytical non-biased evaluation to calculate an index that determines the average expected out-of-pocket burden to be experienced by participants, thus providing an apples to apples (grapes, prunes, etc.) understanding of the financial impact of a particular health plan. In practice, an annual premium may be huge in order to provide a relatively low annual burden for the end user (0% to 20% burden with respect to the annual premium). Thus, the computer implemented methods for the BBCI can help a company or end user to estimate the value of an insurance policy for a particular total annual premium price point.

“ISL” or “Integrated Stop Loss” as referred to in this document in the context of health or other insurance policies or premiums refers to providing a group insurance policy to a company or other group of individuals that is a computer implemented composite insurance policy or health plan, which based in part upon the use of a BCI or a similar cost/benefits index as part of an integrated set of computer implemented methods to help determine the best value of an insurance policy for a particular total annual premium price point and to provide computer implemented coverage under a composite insurance policy or program that reduces the annual burden for an end user to a range of from 0% to 20% burden, i.e., the corresponding BCI as defined above is from 80% to 90%. Optionally, costs can be one reduced further by computer implemented methods for a quick turn of claims payments that works in conjunction with an acceptable group of health services providers having set costs per services agreements with the ISL. The ISL may be directly obtained from the provider, or through an intermediary.

### SUMMARY OF THE INVENTION

The object of the present invention is to provide software and a local or distributed computer or communication network system comprising at least one storage device, at least one memory device, at least one input interface, at least one user interface, and at least one software module running in the memory of such network system with computer implemented broker methods and input methods to provide a cost effective manner for assessing the insurance needs and risks for a company seeking group health insurance coverage and to provide at least one group insurance offering of a single composite insurance solution to such a company, wherein:
(a) at least one group offering provided by computer implemented methods as a single composite insurance solution that assesses all, or substantially all, of the projected total costs for an externally insured, or self-funded, insurance benefits group program for an employer, association, or other acceptable group of individuals, wherein the benefit program is for group members and optionally their dependents or other entitled parties, whether the program is administered internally or externally, comprising:
   (i) determining funding costs for insurance policy coverage,
   (ii) determining insurance policy coverage descriptions, limitations, administrative procedures and other vendor arrangements, and
   (ii) analyzing and calculating by computer implemented methods the costs of benefits premium or funding for coverage as compared to the actual projected total costs for group end users;
(b) insurance services for a group program as described in (a), are provided through a composite insurance solution; and
(c) optionally, the composite group insurance program is managed by the composite insurer as the third party administrator, or by their delegated agent, utilizing computer implemented methods.

A preferred object of the invention is to utilize either a BCI or BBCI analysis for comparing and determining the value for one or more possible group insurance programs.

Another preferred object of the invention is to provide an ISL group insurance program as a composite health insurance solution for an acceptable group.

A still other preferred object of the invention is to provide such a system with computer implemented methods for an online internet or private intranet based composite or other group insurance program wherein the telephone or computer based online service includes computer implement methods, optionally replacing the need for a broker and broker costs by utilizing computer implemented methods, for assessing group rates and premiums and locating one or more composite insurance program providers the group's insurance needs. Preferably, the group insurance program is an integrated stop loss insurance program, having an end user burden that is less than 20% in additional costs beyond the costs of funding or total premium, i.e., a BCI or 80% or greater.

A still further object of the present invention is to provide such a composite insurance policy having a single policy group number, with a single end user group number, such that the end user can utilize a single insurance card to receive services under the policy. In a preferred object, the composite policy has no deductibles, but may have co-pay amounts for the end user to obtain some or all services.

In yet another object of the invention, the system contains computer implemented methods for establishing and administering an ISL group health insurance program for a group that may be chosen by a group after comparison of the BCI and total annual premiums or two or more health insurance programs.

### DETAILED DESCRIPTION THE INVENTION

### Summary of the Drawings or Figures

FIG. 1 is one part of a two part flow chart showing one embodiment of a software implemented set of processes with the logic and ability to produce a “bindable” proposal for employee group insurance for each specific employer who is a prospective client for purchasing group health insurance for their employees, wherein the proposal comprises a listing of costs that would be necessary to establish a stop-loss protected, self-funded employer group health insurance plan (for example an ISL plan) utilizing a Boloto Health Benefits plan document, schedule of benefits, contracted network, TPA and other stop-loss insurance services. In FIG. 1 the Entity/Content/Process “boxes” in the flow chart diagram are indicated by capital letters and the Decision Points “circles” are represented by numbers, and the definitions or detailed descriptions for the capital letters and numbers corresponding to the boxes and circles are set forth in sections below.

FIG. 2 is the second part of a two part flow chart showing one embodiment of a software implemented set of processes with the logic and ability to produce a “bindable” proposal for employee group insurance for each specific employer who is a prospective client for purchasing group health insurance for their employees, wherein the proposal comprises a listing of the costs that would be necessary to establish a stop-loss protected, self-funded employer group health insurance plan (for example a integrated stop loss plan) utilizing a Boloto Health Benefits plan document, schedule of benefits, contracted network, TPA and other stop-loss insurance services. In FIG. 2 the Entity/Content/Process “boxes” in the flow chart diagram are indicated by capital letters and the Decision Points “circles” are represented by numbers, and definitions or detailed descriptions for capital letters and numbers corresponding to the boxes and circles are set forth in sections below.

### OVERVIEW OF THE INVENTION

The present invention is based upon the discovery of that computer implemented methods can be utilized to reduce broker costs and administration costs to thereby lower the costs of major medical insurance for both employees and employees by reducing the overhead from 10% to 40% percent of premium costs. This provides a way for more of the premium dollars to go directly for medical costs and services. Also, an integrated stop loss and/or catastrophic coverage in combination with a computer implemented program procurement and/or program administration reduces the need for out of pocket expenditures beyond the premium costs for a particular price point of annual for deductibles or other out of pocket costs, by permitting a group program procuring individual to compare their acceptable annual funding or premium costs as compared to additional user expenses. Such value savings may permit funding of a similar or better valued major medical insurance program for a group at the same annual costs while adding to coverage catastrophic gap funds or stop-loss funding to reduce or eliminate the gap between limits of the major medical insurance policy program and the beginning of liability obligations of a stop-loss or catastrophic coverage rider policy in addition to a similar valued major medical insurance group program.

The present invention provides software implemented methods and a local or distributed computer or communication network system comprising at least one storage device, at least one memory device, at least one input interface, at least one user interface, and at least one software module running in the memory of such network system with computer implemented broker methods and input methods to provide a cost effective manner for assessing the insurance needs and risks for a company seeking group health insurance coverage and to provide at least one group insurance offering of a single composite insurance solution to such a company, wherein:
(a) at least one group offering provided by computer implemented methods as a single composite insurance solution that assesses all, or substantially all, of the projected total costs for an externally insured, or self-funded, insurance benefits group program for an employer, association, or other acceptable group of individuals, wherein the benefit program is for group members and optionally their dependents or other entitled parties, whether the program is administered internally or externally, comprising:
   (i) determining funding costs for insurance policy coverage,
   (ii) determining insurance policy coverage descriptions, limitations, administrative procedures and other vendor arrangements, and
   (ii) analyzing and calculating by computer implemented methods the costs of benefits premium or funding for coverage as compared to the actual projected total costs for group end users;
(b) insurance services for a group program as described in (a), are provided through a composite insurance solution; and
(c) optionally, the composite group insurance program is managed by the composite insurer as the third party administrator, or by their delegated agent, utilizing computer implemented methods.

A preferred embodiment of the invention utilizes either a BCI or BBCI analysis as part of the methods for comparing and determining the value for one or more possible group insurance programs.

Another preferred embodiment of the invention provides an ISL group insurance program as a composite health insurance solution for an acceptable group.

A still other preferred embodiment of the invention provides such a system with computer implemented methods for an online internet or private intranet based composite or other group insurance program wherein the telephone or computer based online service includes computer implement methods, optionally replacing the need for a broker and broker costs by utilizing computer implemented methods, for assessing group rates and premiums and locating one or more composite insurance program providers the group's insurance needs. Preferably, the group insurance program is an integrated stop loss insurance program, having an end user burden that is less than 20% in additional costs beyond the costs of funding or total premium, i.e., a BCI or 80% or greater.

A still further embodiment of the present invention provides such a composite insurance policy having a single policy group number, with a single end user group number, such that the end user can utilize a single insurance card to receive services under the policy. In a preferred object, the composite policy has no deductibles, but may have co-pay amounts for the end user to obtain some or all services.

In yet another embodiment of the invention, the system contains computer implemented methods for establishing and administering an ISL group health insurance program for a group that may be chosen by a group after comparison of the BCI and total annual premiums or two or more health insurance programs.

In one non-limiting specific embodiment of the invention there is provided a Boloto ISL as follows:
Employer Plan monthly cost=Premium (includes surplus lines tax)+Vendor Costs+Claims Fund Contribution−sent to TPA
Note: In this embodiment each employer may have has their own ERISA trust account (there may be no MET, pooling, or state filing required).
TPA may distribute as follows:
Premium (minus surplus lines tax) is paid to funding/underwriting entity
Vendor Costs are distributed
Claims Fund (employer claims/ERISA trust account) pays all medical bills submitted
   Note: In this embodiment, if during any month(s) of the plan year medical bills exceed the amount in the employer ERISA trust, the fimding/underwriting entity may arrange to cover the money in the deficient account to pay bills. The deficit balance may then be carried over to the end of the plan year with each month starting new.
   At the end of the 12^{th} (12/12), 15^{th} (12/15) or 18^{th} month (12/18):

if there is a deficit balance covered by the funding/underwriting entity through the 12 month term, the employer's ERISA trust will pay back the funding/underwriting entity to zero out the balance.

if there is no or limited money in the ERISA trust at the end of the coverage/carry over, then that covered deficit may be absorbed by the funding/underwriting entity, which may itself be optionally covered by an external catastrophic coverage policy to provide for such funding contingencies.

if there is a balance in the ERISA trust after coverage/carry over, the control of the funds returns completely back to the employer.

Note: there are no funds paid into the ERISA trust by employer beyond the 12th month.

In one embodiment of the Boloto ISL system implementation, as described above, the system can have broker/agent distribution capability from the website, which may or may not increase the plan costs to the group or end user. In one preferred embodiment, the plan cost for a group is identical regardless of whether the program is obtained by direct web access or brokered by an intermediary, since the web provider can pay a fee to the broker out of proceeds and absorb the broker costs.

Of course, a preferred embodiment of the invention provides such a system with computer implemented methods for an online internet or private intranet based composite insurance program wherein the telephone or computer based online service includes computer implement methods that replace the need for a broker and broker costs by utilizing computer implemented methods for assessing group rates and premiums and locating one or more major medical insurance company matching the company's major medical group insurance needs, along with a stop-gap insurer as a re-insurer of the major medical insurance policy. Thus, a broker or other intermediary may be optional to the party seeking a group plan.

A still further embodiment of the present invention provides such a composite insurance policy having a single policy group number, with a single end user group number, such that the end user can utilize a single insurance card to receive services under the policy. In a preferred embodiment, the composite policy has low or no deductibles, and may have low to no co-pay amounts for the end user to obtain some or all services.

In one embodiment of the invention, the computer implemented methods utilize a “BCI” or “benefits cost index” in the context of health or other insurance policies or premiums by utilizing computer implemented methods with computer implemented actuarial analysis methods conducted for the evaluation of a health benefits value factoring as a method to determine the true financial impact of health plan costs and benefits. Generally, such computer implemented methods analyze the benefit, burden or both the benefit and burden of an insurance policy for an individual or group of individuals based upon values that may be calculated or input with respect to the average cost of insurance coverage divided by the projected cost of end user coverage use. The result is the Benefits Cost Index (BCI), which is essentially the portion of total costs that are covered for a particular premium costs without any out of pocket. Logically, the lowest total annual premium costs with the highest BCI (lowest out of pocket percentage with respect to the coverage) might be regarded as representing the best value for end users. A consumer choice might be to seek the lowest annual premium costs having an acceptable BCI with regard to out of pocket expenditures. An employer might have an interest that seeks to lower the premium costs, while an end user might have an interest that seeks to lower out of pocket expenditures beyond the premium, and computer implemented methods that determine a BCI for a particular premium cost can be utilized as a factor to strike a balance between the two interests.

Likewise, the “BBCI” or “Boloto Benefits Cost Index” as referred to in this document in the context of health or other insurance policies or premiums refers to computer implemented methods that utilize a BCI as defined above which calculates multiple factors including project end user use, deductibles, co-insurance, co-pays, etc. and delivers a benefit number. This may be utilized to compare two or more group programs with respect to costs and benefits. For example, the BCI number may be expressed as a percentage from 0 (all burden) to 100 (no out-of-pocket) for each dollar of utilization in a group plan. Alternatively, the benefit number may be subtracted from 100% to provide the percent burden of a particular policy as a percentage of the premium costs. The BBCI can be utilized in an analytical non-biased evaluation to calculate an index that determines the average expected out-of-pocket burden to be experienced by participants, thus providing an apples to apples (grapes, prunes, etc.) understanding of the financial impact of a particular health plan. In practice, an annual premium may be huge in order to provide a relatively low annual burden for the end user (0% to 20% burden with respect to the annual premium). Thus, the computer implemented methods for the BBCI can help a company or end user to estimate the value of an insurance policy for a particular total annual premium price point.

The embodiment of the Boloto “ISL” or “Integrated Stop Loss” as referred to in this document in the context of health or other insurance policies or premiums refers to providing a group insurance policy to a company or other group of individuals that is a computer implemented composite insurance policy or health plan, which is based in part upon the use of a BCI or a similar cost/benefits index as part of an integrated set of computer implemented methods to help determine the best value of an insurance policy for a particular total annual premium price point and to provide computer implemented coverage under a composite insurance policy or program that reduces the annual burden for an end user to a range of from 0% to 20% burden, i.e., the corresponding BCI as defined above is from 80% to 90%. Optionally, costs can be one reduced further by computer implemented methods for a quick turn of claims payments that works in conjunction with an acceptable group of health services providers having set costs per services agreements with the ISL. The ISL may be directly obtained from the provider, or through an intermediary.

### DETAILS, EXAMPLES OR IMPLEMENTATIONS OF THE INVENTION

The cost savings of the composite programs described above can be utilized to provide integrated or separate stop loss coverage prior to a catastrophic policy kicking in to pay for out of pocket or deductibles. Ordinarily aggregate stop loss coverage liability does not vest until a corridor figure of at least 125% of last year's aggregate liability is met, or 25% above the current major medical insurance policy aggregate liability limits. By contrast the integrated stop loss program (ISL) can combine specific and aggregate to provide a no-gap stop loss coverage that can eliminate or reduce the 25% individual or group gap or other significant gap that can be costly to the insured before a stop loss liability obligation to pay for major medical insurances would vest. This ISL coverage can be a fully-funded stop loss policy and the individual policy holders claims can be paid out of group funds up to the exhaustion of the group funds, at which point the no-gap stop loss catastrophic coverage or other funding can begin to pay all claims under the policy.

One integrated stop-gap composite policy may be a self-funded employer stop-loss program under a single policy or may utilize an outside funder. This composite can be designed to provide stability, efficiency, flexibility and creativity, as follows:
Stability—Employer expenses remain steady every month.
Efficiency—Competitiveness to buyer moving from fully insured plan.
Flexibility —Avoid state mandates.
Creativity—Underlying plan design with no-gap design can avoid individual employee out of pocket costs.

Some factors that can contribute to total healthcare costs for an employer are (a) determinants of health status of employees, such as (i) access to care (10%), (ii) genetics (20%), (iii) environment (20%) and behavior (20%), (b) distribution of medical services use among types of employees that result in a use distribution analysis, (c) doubling of total health benefit costs to employer per employee from 1994 to 2004, and (c) employer trends and behavior changes to help contain such costs through (i) increases with copays and deductions, (ii) actions to curb excessive use of medical services among some employee types, (iii) increased trends toward self-insurance with catastrophic underwriting, and (iv) reduced medical benefits.

Risk factors and employer trends point to the depth of the problem of increased health care costs with increased employer and employee costs along with the need for a system to address points of greatest cost or risk with an computer implemented set of steps to address such issues and costs.

In one embodiment the present includes the computer implemented steps of:

(a) receiving at a computer interface or via another data source, a set of underwriting limitations from a set of each of a major medical insurance provider and a catastrophic or stop loss medical insurance provider with respect to risk, policy limits, premiums rate per risk and set of questionnaires that need to be answered for each insurance provider in order to obtain an appropriate risk score for a given premium rate from that insurance provider;

(b) calculating a premium and set of policy limitations of each provider provide a composite ISL policy providing specific group and stop-loss coverage with a minimum of out of pocket costs (or no gap between the major medical and the stop-loss coverage;

(c) compiling a first set of statistics in a data processing system based upon the data and desired composite sets of policy offerings;

(d) calculating a premium for an ISL policy, and optionally adding in a third party administrator fee or consulting fee before providing a monthly premium quote;

(e) calculating a premium amount for the group and sets of premium for individual risk classes within the group;

(f) outputting from the data processing system the sets of statistics, names of sets of composite insurance policies and respective premiums necessary for meeting a set of plan objectives, and ISL criteria; and

(g) providing a price per a set of policy amounts and risk criteria that can be matched with an group insurance needs and their risk data.

A preferred embodiment, provides a set of questionnaires and data entry interfaces for a potential group insurance customer or their representative to input risk data and insurance needs from which a policy quote can be generated by matching the risks and needs to the pricing criteria provided by steps (a)-(g).

Another preferred embodiment utilizes a BCI or BBCI to compare health insurance policies costs and benefits, and to compare ISL or other composite programs.

In a preferred embodiment the invention provides the above method, comprising the further steps of:

(i) outputting from said data processing system one or more quotes based upon the data processing underwriting risk assessment results and the cast for the type of insurance and needs that the end user wishes to insure;

(ii) receiving at said data processing system online internet, interface an offer to purchase insurance services a quoted rate, pending verification of the risk and needs criteria that were input by the company requesting insurance coverage, and

(iii) optionally providing a revocable binding quote and immediate coverage, where the policy will be binding if the data input by the customer is verified to be accurate, and/or optionally,

(iv) providing one or more interfaces and computer implemented methods containing logic and methods to present to a customer a BCI or BBCI comparison of two or more health insurance plans.

Insurance Seeking Companies

Companies seeking group health insurance coverage and catastrophic coverage will find that the present system provides a number of advantages.

The online or telephonic ISL composite system and computer implemented methods according to the present invention provide a company seeking group medical insurance coverage with a single location with applications and forms that can be filled out one time for the coverage needed.

The system assesses the company's needs and the insurance providers available and assesses the types of policies available to provide a composite full coverage policy with integrated stop loss coverage. In one embodiment, the system also assesses the needs for a third party administrator and can provide all of the administration of funds, claims and questions for the insured.

The system adapts a composite ISL policy and its components to meet the needs of the person seeing the insurance to establish a single bill and premium for the ISL policy plan as a one stop insurance provider.

Insurance Providing Companies

The present system provides a free underwriting service to insurance companies who wish to offer insurance, since the costs are known and provided entirely as a service for the company seeking insurance. By providing the data for the present underwriting system and updating frequently, the insurance providers do not need to have a separate underwriting department, or will have less need for such data processing equipment or people. The BCI functionality can provide a good cost for desired level of benefit analysis for the company. The consulting fees for providing an ISL policy to the company seeking insurance will cover the underwriting system costs.

The present system can also remove or reduce the need for advertising by the insurance providing companies, since the consumer will come directly to the online ISL and underwriting site to obtain insurance and the best premium for the needs of that company seeking insurance (best BCI for a particular total annual premium price point) to obtain the business without any advertising.

Companies seeking to be self insured can utilize the BCI computer implemented methods to better determine how to plan for a self-insured health plan.

The present system will save insurance providing companies the cost of having a sales staff and providing commissions for insurance sales. No commission is necessary for the online underwriting system to determine whether a sale is in the interest of both the insurer and the company to be insured.

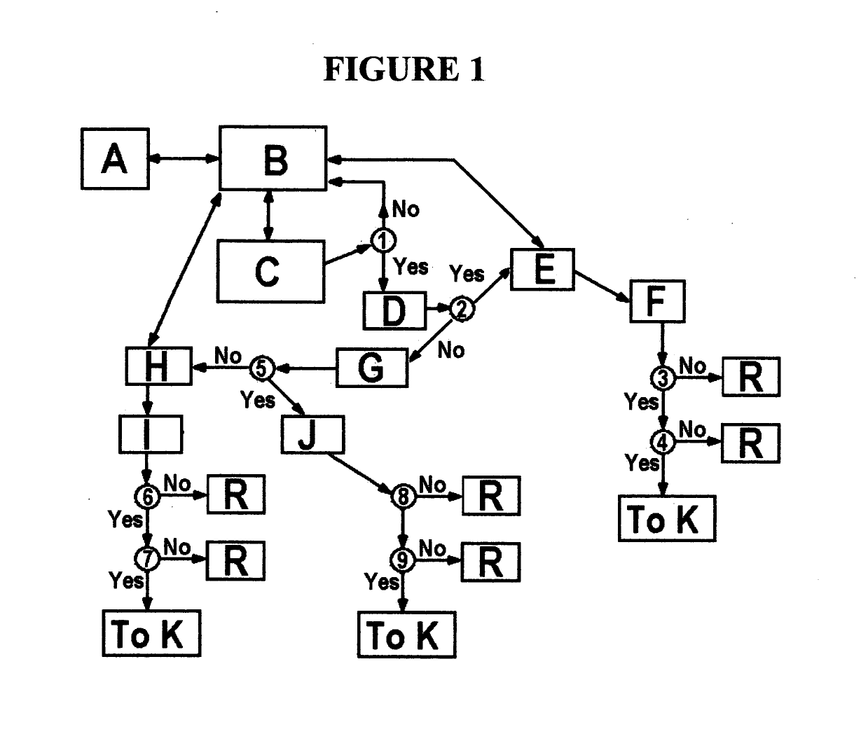

The following Example 1 describes in detail the flow charts elements of FIG. 1 and

FIG. 2 and is merely one non-limiting example of a single particular embodiment of the Boloto ISL Model and its associated software implemented processes. Such procedures can be easily adapted for a comparison of any two insurance plans or programs, not just two or more ISL plans.

### Example 1

In this example, FIGS. 1 and 2 are a two-part flow chart illustrating one embodiment of a software implemented set of processes with the logic and ability to produce a “bindable” proposal for employee group insurance for each specific employer who is a prospective client for purchasing group health insurance for their employees, wherein the proposal comprises a listing of the costs that would be necessary to establish a stop-loss protected, self-funded employer group health insurance plan (for example an ISL plan) utilizing a Boloto Health Benefits plan document, schedule of benefits, contracted network, TPA and other stop-loss insurance services. In each of the figures, the Entity/Content/Process “boxes” in the flow chart diagram are indicated by capital letters and the Decision Points “circles” are represented by numbers. The definitions or detailed descriptions for the capital letters and numbers (“keys to the flow chart”) corresponding to the boxes and circles are set forth in detail below.

In each of FIGS. 1 and 2, “A” is a box representing the “Employer” who is an entity that is providing or wishes to provide a group health insurance program to its employees, and that wishes to obtain a quotation for consideration of purchase.

In each of FIGS. 1 and 2, “B” is a box representing the “Intermediary” who is an entity serving as the liaison between the prospect employer and the financing vehicle/underwriting entity. The intermediary may be an agent, broker, consultant, or a marketing representative of a TPA or insurance entity.

In FIG. 1, “C” is a box representing the “Financing vehicle/underwriting entity” who is usually an insurance entity and may be one or more of an insurance company, HMO, health plan, or an authorized representative of such entities, such as a Managing General Underwriter, or may even simply a TPA in the case of a fully self-insured employer (meaning, there is NO stop-loss insurance). If the “risk” represented by the health insurance program is held entirely and solely by the employer, then there is no transfer of risk to an insuring entity of any kind. An insurance company may offer administrative services only without any insurance element, in which case they serve in the identical capacity of a TPA. A TPA may be both the servicing agent for the administrative services required for an insurance program and the intermediary between the client and an insuring entity for any transfer of risk (insurance element). In this example embodiment, the financing vehicle is a self-funded health plan WITH the presence of stop-loss insurance. In this embodiment, a TPA is involved only in the capacity of administrative services for a case that has reached the “sold case” status point, and does not provide an intermediary role, at least not for the initial contact and placement. Also, in this embodiment an insurance company is involved as the issuer of the stop-loss policy. In FIGS. 1 and 2 they are represented in the example process by the MGU as regards the rating, underwriting, policy issue, and policy and claims administration of the stop-loss insurance coverage.

In FIG. 1, the circle “1” represents a decision point where the system needs to determine whether the software implemented processes of the system have gathered all the relevant INITIAL information required to start the ISL Model underwriting process has been provided to the underwriting entity. In this embodiment of the software implemented processes, this means software implemented logic must determine at this step if the system has gathered the basic information with respect to the employer name, employer address, SIC code, the proposed effective date of the insurance coverage, and the necessary census information on each employee who currently has, or is expected to have, insurance coverage in the employer's plan. If the system determines that such initial information has been provided, then the system logic can allow the software implemented processes to move on to box “D” as described below, if not, the information needs to be clarified and must obtained from the intermediary or employer, or they system will simply terminate the processes (represented by a loop back to the “B” box where more information is gathered or the process is terminated).

In FIG. 1, “D” is a box representing generation of a “Preliminary Quote”, or “PQ” based upon the initial required information that was gathered to this point and the preparation of the PQ can be automatically generated based upon a Manual Rate Engine (MRE) set of logic and rules applied to the initially gathered information. In one embodiment, the MRE calculates an initial, preliminary cost estimate of the proposed insurance program utilizing an actuarially based group health insurance rating manual approved by the insurance carrier involved, in this case the stop-loss insurance carrier. It presumes all the parameters (rules and limits) taken from a current Boloto Health Benefits plan, benefits, limits, network, and also takes into consideration similar relevant factors normally taken into consideration by an actuarial rating manual. In this embodiment, the resulting PQ is NOT bindable, but, if shown to the prospect, indicates that it is merely an initial indication of the estimated cost of the ISL insurance program, but the actual cost will depend on additional information that will be required to be submitted for more formal consideration. In this embodiment, all cases must move through an “acknowledgement” check-off page where potential clients seeking group insurance can view a summary of the benefit plan and will be required to check-off their agreed upon understanding of certain facts about the Boloto Benefit Plan in order to go further in the software implemented processes of this example embodiment. At “D” point in the step is completed prior to having the PQ's “split” off into logical process loops according to a classification of case size (number of people requiring insurance). There is a pre-selected “size” parameter that determines whether or not the prospect is shown the PQ following the disclosure acknowledgement. If the case is below that point in size, the PQ is shown and the prospect can choose to go forward or not. If the case is at or above that size cut-off, then the PQ is not shown, and the prospect is sent right into the next decision point. (Note that a PQ is calculated in either case, and the manual rating result utilized in the later underwriting processes.) No matter what, cases moving forward go to the next decision point “2”.

In FIG. 1, “2” is a circle representing the decision point were it is determined if the insurance prospect is to be classified as a “virgin” case. (In this embodiment, a virgin case is one that does not currently have an employer sponsored health insurance program in place, whether they have had one in the past or not.) In this embodiment, virgin cases require a separate “pathway” to reach the point of making a formal, bindable offer of coverage. Hence, if the prospect is a virgin case, they move to box “E”, and if not, they move to box “G”.

In FIG. 1, “E” is a box representing the logical step in this embodiment where additional information must be obtained from the prospect. Such additional information usually takes the primary form of an electronic or hard copy enrollment card (that can be electronically entered in this system” for each employee, wherein the form includes an Evidence of Insurability (EOI) section. In this embodiment, a properly completed EOI card must be submitted to the MGU for every employee. The system provides for a “loop” back to the intermediary/employer at box “B” in order to communicate this need and address any omissions in order to provide the appropriate documents, and obtain the completed forms. If a potential client is unable to provide the required information, the process terminates at point “B” of the flow chart. If they do, then the process moves on to box “F” or back through box “E” to box “F” of the flow chart.

In FIG. 1, “F” is a box representing where an MGU applies the logical processes and rules of the underwriting/rating engine, which utilizes the EOI information to modify the PQ, and to determine what is necessary to make as a formal, bindable quote offer. In this embodiment, the engine utilizes certain accepted actuarial and/or medical underwriting criteria rules in a logical form in evaluating the information included in the EOI forms, and utilizes software implemented processes, facts and rules to determine the impact of such information on manual rates/costs that take the information into account.

In FIG. 1, “3”, is a circle representing the decision point to determine whether a Formal Quotation (FQ) is offered to the client. If the decision is yes, then the process moves on to next decision point (decision point “4”). If no, then the automated process is terminated at a rejection box (“R”) where certain considerations must be met by a manual review of a real person or a secondary logical process before returning to an automated process step of this embodiment.

In FIG. 1, “4” is a circle representing the decision point to determine whether the prospect also indicates their acceptance of the FQ that was provided at the decision point “3” as described above. If no, then the automated process is terminated at a rejection box (“R”) where certain considerations must be met by a manual review of a real person or by a secondary logical process before returning to an automated process step of this embodiment, then move to termination process. If yes, then the process moves on to box “K”** that continues on to logic flow in FIG. 2.
**Note that Box “K” of FIG. 2 is discussed later, as three different pathways of FIG. 1 can be utilized to arrive at Box “K” of FIG. 2. The two other logical paths of FIG. 1 that are based upon alternative answers at various decision points are described below in detail before continuing with a further discussion of paths through Box “K” of FIG. 2.

In FIG. 1, “G” is a box representing the branching off of logical paths where the case is not a virgin case and further information is obtained on the history/experience of the employer's current and previous plan in order to proceed. This information is submitted and evaluated. At this point, another decision is made about which branch of the flow to proceed down.

In FIG. 1, “5” is a circle representing the decision point regarding the status of the prospect in conjunction with regard to the information submitted and whether such information is sufficient to allow for an “automated” underwriting engine/system process to generate a bindable quote offer. If yes, then move to box “J” and its logical processes toward rejection or box “K”. If not, then the system moves to box “H”.

In FIG. 1, “H” is a box representing the gathering of whatever additional information/clarification needs to take place with the intermediary/prospect in order to allow for an “automated” underwriting engine/system process to generate a bindable quote offer proceed to automated underwriting. This may include requiring submission of the same EOI forms required for virgin cases (in the event, for example, that even though an employer has current coverage, the information provided is adjudged by the underwriting engine/system to be insufficiently reliable and so the more detailed information reflected in the EOI forms is required), it may require clarification of certain ongoing large claim conditions, etc. with logical loops back to box “B” of FIG. 1. Whatever the reason for diversion to a logical branch with box “H”, if the communication is successful, then underwriting can take place by proceeding to box “I”, if not, then the process can terminate at box “B” of FIG. 1.

In FIG. 1, “I” is a box representing a continuing of the process from box “H” where an underwriting/rating engine can be applied to the now sufficient package of gathered information.

In FIG. 1, “6” is a circle represent the decision point for determining whether an FQ is offered to the prospective client. If yes, then the logical processes move on to the next decision point circle “7”. If no, then the automated process is terminated at a rejection box (“R”) where certain considerations must be met by a manual review of a real person or by a secondary logical process before returning to an automated process step of this embodiment, then move to termination process. Decision point circle “6” utilizes the same criteria and is equivalent to decision point circle “3” of FIG. 1.

In FIG. 1, “7” is a circle represent the decision point for determining whether the insurance prospect client indicates acceptance of the FQ. If no, then the automated process is terminated at a rejection box (“R”) where certain considerations must be met by a manual review of a real person or by a secondary logical process before returning to an automated process step of this embodiment then move to termination process. If yes, then the logical process moves on to box “K”. Decision point circle “7” utilizes the same criteria and is equivalent to decision point circle “4” of FIG. 1.

In FIG. 1, “J” is a box representing a continuing of the process from a “YES” at decision point circle “5” of FIG. 1. At this point an underwriting/rating engine is applied to the information that has been collected and adjudged by the system to be sufficient to provide an automated underwriting decision. Note that the process of boxes F, H, and J are essentially the same, though the kinds of information used, and the calculation steps actually utilized may be different. The similarity of each of these points is that sufficient information is present for an underwriting decision to be made about whether or not to make an offer (and to establish the contents of that offer).

In FIG. 1, “8” is a circle represent the decision point for determining whether an FQ is to be offered to the client. If yes, then move to the next decision point (circle “9”). If no, then the automated process is terminated at a rejection box (“R”) where certain considerations must be met by a manual review of a real person or by a secondary logical process before returning to an automated process step of this embodiment then move to termination process. Decision point circle “8” is essentially the same as either of decision point circles “3” and “6” of FIG. 1.

In FIG. 1, “9” is a circle representing the decision point for determining whether an insurance prospect client indicates acceptance of the FQ. If no, then the automated process is terminated at a rejection box (“R”) where certain considerations must be met by a manual review of a real person or by a secondary logical process before returning to an automated process step of this embodiment. If yes, then the logical process moves on to box “K”. Decision point circle “7” utilizes the same criteria and is equivalent to decision point circle “4” of FIG. 1. Decision point circle “9” is essentially the same as decision point circles “4” and “7” of FIG. 1.

In FIG. 2, “K” is a box representing a continuation of the process flow charts from a “YES” at decision point from either of the three decision circles “4”, “7” of “9” from FIG. 1 leading to each of the corresponding boxes in FIG. 1 labeled as “To K” and which continue on to actual box “K” of FIG. 2. At this point, the insurance client prospect (employer) will go through a second level of disclosure acknowledgement where they are required to check-off the presence or absence of certain fact disclosures and to acknowledge statements of understanding before going any further. If they refuse to complete or are unable to complete the required information and acknowledgements they are moved to the automated process is terminated at a rejection box (“R”) status where certain considerations must be met by a manual review of a real person or by a secondary logical process before returning to an automated process step of this embodiment, for example, they could be moved to a termination of process status, or assigned to a special handling by an actual customer service unit that may attempt to resolve any problems and retain the sale. After this completion, they move to a decision point circle “10” where they are provided with certain documents that must be completed and communicated to the Boloto TPA to formalize the establishment of a “sold” case, or they will be returned to box “K” for further processing. For example, these documents could include electronic or manual forms necessary for completing the “final” underwriting and the stop-loss policy issue process, establishing the necessary ERISA vehicle for self-funding, agreements for TPA services, and submission of initial funds or banking arrangements.

In FIG. 2, “10” is a circle representing the decision point for determining if certain documents that must be completed and communicated to the Boloto TPA to formalize the establishment of a “sold” are all completed and downloaded/obtained by the insurance client prospect (employer). If no, the are returned to box “K” for further processing and communications where communications reinforce the requirement that such documents must be received by the prospect, or if such attempts fail for some number of times, then automated process may be terminated at a rejection box (“R”) status where certain considerations must be met by a manual review of a real person or by a secondary logical process before returning to an automated process step of this embodiment. If yes, then the flow chart processes move the client on to box “L”.

In FIG. 2, “L” is a box representing the process step of this embodiment where the necessary documents from decision point circle “10” are received by the TPA who sorts through them and reviews them for completeness and correctness.

In FIG. 2, “11” is a circle representing the decision point for determining if all the documents received by the TPA have been submitted correctly and completely by the prospective insurance client (employer). If the decision is “No”, then the case is moved to box “L1”. If the decision is “Yes”, then the TPA or automated system forwards the necessary subset of such documents to the MGU for processing at box “M”.

In FIG. 2, “L1” is a box representing the process step of this embodiment with regard to a sub-role of the TPA, which is to interface with the prospect for the purpose of completing/correcting missing or incorrect documents required from one or more of the prior steps and communications may be routed back and forth directly or indirectly between boxes “L1” and “B” or may be further re-routed back through the flow chart of FIG. 1 from “B” under the coordination of the TPA in order for the prospective insurance client “employer” to correct any errors or to make any changes. The ideal result for such interactions is a “resubmit” to box “L” of updated information, or an undesired result may be a final rejection of the prospective insurance client (employer) due to noncompliance or other reasons discovered via this communication process. If the updated information is not forthcoming, then terminate the prospect.

In FIG. 2, “M” is a box representing the process step of this embodiment where the MGU takes their portion of the packet of required information from the TPA that they will need to accomplish two final functions in order for the prospective insurance client (employer) to be able to move through decision point circle “12” of the flow chart. The first function is for the MGU to go through a “final or sold case underwriting” process that takes the documentation (including hard-copy evidence of the digitally input information used in the original underwriting process) submitted by the prospect, the actual final census information, and other required disclosure information that is part of the documentation packet, and reviews one more time the “sold” offer of coverage that was accepted by the prospect. If nothing significant has changed (according to their underwriting rules and regulations making up the underwriting “engine”), then the stop-loss policy can be issued at decision point circle “12” by utilizing the official documentation provided.

In FIG. 2, “12” is a circle representing the decision point for determining if the description of necessary analysis and review as found in box M has been satisfactorily completed in order for a stop-loss policy to issue. Essentially, the question is “Will the sold Formal Quote parameters stand based on the submitted documentation?” If yes, then move to box “N”. If no, then move to box “M1”.

In FIG. 2, “M1” is a box representing the process step of this embodiment that provides an extra process loop of communication back through the TPA (who now plays the role of intermediary AFTER the point of a preliminarily sold case) to explain why the original Formal Offer has to be changed (because information changed, or wasn't consistent, or the number of people changed, etc.), and either asking for further information, or making a counter-offer based on the latest information. This creates a loop where the communication goes to the TPA at box “L1” to the prospect at box “B” back to the TPA at box “L1” followed by a resubmit to box “L”, and ultimately back to the MGU at box “M” until either they all “agree” on revised terms that can be “issued” in the stop-loss policy, or the prospect or MGU decide to cancel the sale. The loop keeps coming back through decision points “12” and “13” until such a final agreement or rejection determination is made.

In FIG. 2, “13” is a circle representing the decision point in the sub-loop for determining whether to continue on to box “L1” for a continued updating and negotiating process for a final agreement on terms (see decision made at point 12), or the entire process is terminated at rejection box (“R”) where certain considerations must be met by a manual review of a real person or by a secondary logical process before returning to an automated process step of this embodiment and the preliminary “sale” is canceled.

In FIG. 2, “N” is a box representing the process step of this embodiment where the MGU issues formal policy documents and sends appropriate copies to the TPA for delivery to the new account.

In FIG. 2, “O” is a box representing the process step of this embodiment where the TPA delivers final documents to the new client, finishes setting up all necessary internal arrangements for ongoing administration of the account (banking, computer records, etc.), completes any final “adjustment” accounting required based on final issued cost parameters of the stop-loss policy and any other initial “one off” charges to establish the plan, issue ID cards, etc.

In FIG. 2, “P” is a box representing the process step of this embodiment where the normal “issued case” has processes related to ongoing premium collections, funding, and claims activities for the term of the contract period.

The present may be embodied in specific forms other than those particularly described above or illustrated by the appended drawings. Upon viewing the present application preferred embodiments and other descriptions herein of the present invention, variations and other implementations that do not depart from the spirit and scope of the present invention will be apparent to one of routine skill in this field. Such variations and other implementations are considered part of the present invention and within the scope of the appended claims. Accordingly, reference should be made to the appended claims, rather than to the forgoing specification and drawings, as indicating the scope of the present invention.

I claim:

1. Software implemented methods and a local or distributed computer or communication network system comprising at least one storage device, at least one memory device, at least one input interface, at least one user interface, and at least one software module running in the memory of such network system with computer implemented broker methods and input methods to provide a cost effective manner for assessing the insurance needs and risks for a company seeking group health insurance coverage and to provide at least one group insurance offering of a single composite insurance solution to such a company, wherein:
(a) at least one group offering provided by computer implemented methods as a single composite insurance solution that assesses all, or substantially all, of the projected total costs for an externally insured, or self-funded, insurance benefits group program for an employer, association, or other acceptable group of individuals, wherein the benefit program is for group members and optionally their dependents or other entitled parties, whether the program is administered internally or externally, comprising:
(i) determining funding costs for insurance policy coverage,
(ii) determining insurance policy coverage descriptions, limitations, administrative procedures and other vendor arrangements, and
(ii) analyzing and calculating by computer implemented methods the costs of benefits premium or funding for coverage as compared to the actual projected total costs for group end users;
(b) insurance services for a group program as described in (a), are provided through a composite insurance solution; and
(c) optionally, the composite group insurance program is managed by the composite insurer as the third party administrator, or by their delegated agent, utilizing computer implemented methods.

2. Software implemented processes according to claim 1, wherein the system with software implemented methods is an online internet or private intranet based set of processes providing access to a composite ISL group insurance program wherein the telephone or computer based online service includes computer implemented methods that make having a broker optional when obtaining a group insurance policy by replacing the need for a broker and expense of broker costs via computer implemented methods for assessing group rates and premiums and locating one or more ISL policy matching the company's medical group insurance needs.

3. Software implemented processes and system according to claim 1, wherein the system with software implemented methods utilizes either a BCI or BBCI analysis as part of system methods for comparing and determining the value for one or more possible group insurance programs

4. Software implemented processes and system according to claim 2, wherein at least one group insurance plan offered by the system is an ISL program, having an end user burden that is less than 20% in additional costs beyond the costs of funding or total premium, i.e., a BCI or 80% or greater.

5. Software implemented processes and system according to claim 4, wherein the end user burden is from 0 to 10% with a BCI or 90% or greater.

6. Software implemented processes and system according to claim 4, wherein the end user burden is from 0 to 5% with a BCI or 95% or greater.

7. Software implemented processes and system according to claim 4, wherein the system provides an interface and computer implemented logic to present a list of insurance plans within a certain user burden range in ascending or descending order, or both, of highest or lowest total annual premium costs or funding costs, or plans having a total annual premium cost within a range of costs are presented in their ascending or descending order of burden or benefit, such as a BCI order.

8. Software implemented processes and system according to claim 1, wherein the system contains computer implemented methods for establishing and administering an ISL group health insurance program for a group that may be chosen by as a group plan after the system presents a comparison of one or more sets of the BCI and total annual premiums costs for two or more health insurance programs

9. A software implemented methods and a local or distributed computer or communication network system, according to claim 1, with computer implemented broker methods and input methods to provide a cost effective manner for assessing the insurance needs and risks for a company seeking major medical insurance and to provide at least one group insurance offering of a single composite insurance solution to a company seeking group major medical insurance coverage with catastrophic coverage, wherein:
(a) at least one group offering provided by a computer implemented methods is a single composite insurance solution having at least at least three insurance components, comprising:
(i) a major medical insurance policy coverage,
(ii) an aggregate major medical police insurance coverage, and
(ii) a “no-gap” stop-loss or catastrophic coverage, wherein no-gap means that the stop-loss or catastrophic policy liability coverage begins when the individual aggregate limits for liability payments or group aggregate limits for liability payments are substantially met;
(b) insurance services for the composite insurance policy are provided to end users through a single policy premium and a single claims method of administration; and
(c) composite insurance including the at least three components is managed by the composite insurer as the third party administrator, or by their delegated agent.

10. Software implemented processes according to claim 9, wherein there is provided a composite insurance policy having a single policy group number, with a single end user group number, such that the end user can utilize a single insurance card to receive services under the policy.

11. Software implemented processes according to claim 10, wherein the composite policy has low or no deductibles and has low or no co-pay amounts for the end user to obtain some or all services.

12. Software implemented processes according to claim 9, wherein the computer software implemented steps include the computer software implemented steps of:
(a) receiving at a computer interface or via another data source, a set of underwriting limitations from a set of two or medical insurance provider with respect to risk, policy limits, premiums rate per risk and set of questionnaires that need to be answered for each insurance provider in order to obtain an appropriate risk score for a given premium rate from that insurance provider;
(b) calculating an annual premium and set of policy limitations for each provider policy and calculating a BCI for two or more composite ISL insurance policies;
(c) compiling a first set of statistics in a data processing system based upon the data and desired composite sets of policy offerings;
(d) calculating a premium for a composite ISL policy, and optionally adding in a third party administrator fee or consulting fee before providing a monthly premium quote, optionally with a BCI score included;
(e) calculating a premium amount for the group and sets of premium for individual risk classes within the group;
(f) outputting from the data processing system the sets of statistics, names of sets of composite insurance policies and respective premiums necessary for meeting a set of policy criteria; and
(g) providing a price per a set of policy amounts and risk criteria with a BCI that can be matched with an group insurance needs and their risk data.

13. Software implemented processes according to claim 12, wherein at least one interface of the software implemented process provides a set of questionnaires and data entry interfaces for a potential group insurance customer or their representative to input risk data and insurance needs from which a policy quote can be generated by matching the risks and needs to the pricing criteria provided by steps (a)-(g).

14. Software implemented processes according to claim 13, comprising the further steps of:
(i) outputting from said data processing system one or more quotes based upon the data processing underwriting risk assessment results and the cast for the type of insurance and needs that the end user wishes to insure;
(ii) receiving at said data processing system online internet, interface an offer to purchase insurance services a quoted rate, optionally with a BCI score, pending verification of the risk and needs criteria that were input by the company requesting insurance coverage, and
(iii) optionally providing a revocable binding quote and immediate coverage, where the policy will be binding if the data input by the customer is verified to be accurate.

15. Software implemented processes according to claim 12, comprising the processes logic and rules as set forth in the flow charts of FIGS. 1 and 2 and described in the body text of this application.

16. A local or distributed computer or communication network system comprising at least one storage device, at least one memory device, at least one input interface, at least one user interface, and at least one software module running in the memory of such network system with computer software implemented broker methods and input methods to provide a cost effective manner for assessing the insurance needs and risks for a company seeking major medical insurance and to provide at least one group insurance offering of a single composite ISL insurance solution to a company seeking group major medical insurance coverage with integrated stop loss coverage, wherein:
(a) at least one group offering provided by a computer implemented methods is a single composite insurance solution having at least at least three insurance components, comprising:
(i) a major medical insurance policy coverage,
(ii) an aggregate major medical police insurance coverage, and
(ii) a “no-gap” stop-loss or catastrophic coverage, wherein no-gap means that the stop-loss or catastrophic policy liability coverage begins when the individual aggregate limits for liability payments or group aggregate limits for liability payments are substantially met;
(b) insurance services for the composite insurance policy are provided to end users through a single policy premium and a single claims method of administration; and
(c) composite insurance including the at least three components is managed by the composite insurer as the third party administrator, or by their delegated agent.
